(19) United States
(12) Patent Application Publication
(10) Pub. No.: US 2013/0135211 A1
(43) Pub. Date: May 30, 2013

(54) KEYBOARD

(71) Applicant: Darfon Electronics Corp., Taoyuan (TW)

(72) Inventors: Chih-Hsiang Chiang, Taoyuan (TW); Chin-An Wang, Taoyuan (TW)

(73) Assignee: Darfon Electronics Corp., Taoyuan (TW)

(21) Appl. No.: 13/677,321

(22) Filed: Nov. 15, 2012

(30) Foreign Application Priority Data
Nov. 29, 2011 (TW) 100143693

(51) Int. Cl. G06F 3/02; G06F 3/044

(52) U.S. Cl. CPC G06F 3/02; G06F 3/044
USPC 345/168

(57) ABSTRACT

A keyboard is disclosed and includes a base plate, a plurality of key structures, a plurality of switches, and a capacitive touch sensing device. Each of the key structures is disposed above the bottom plate and includes a keycap capable of moving up and down relative to the base plate. Each of the switches corresponds to one of the keycaps and is disposed under the corresponding keycap. Each of the keycaps is capable of moving toward the base plate to trigger the corresponding switch. The capacitive touch sensing device is disposed under the key structures, for sensing a touch operation performed on the keycaps. The functionality of the keyboard of the invention therefore improves. The keyboard uses an identical projection area to perform keying and touch operation, which avoids the inconvenience for a user when using both a keyboard and a touchpad in the prior art.

### BACKGROUND OF THE INVENTION

1. Field of the Invention

The invention relates to a keyboard, and especially relates to a keyboard with touch function.

2. Description of the Prior Art

Current keyboards applied to electronic devices usually have input function by keys. If a user needs touch function such as for controlling cursor or drawing figures, the electronic device needs to be connected with a touchpad for the user. However, the disposition place for a keyboard plus a touchpad is not so small, leading to insufficient work space for the user. Moreover, a plurality of connection cables between the peripheral devices and the electronic device make the work space disorderly, leading to interference with work of the user more. Furthermore, the user needs to move his hand between the two peripheral devices from time to time for changing inputting such as keying and touch operation, leading to increasingly inconvenience in use. In addition, if the keyboard and the touchpad are physically separate, the actual disposition therefor is usually stationary, which restricts the operation gesture of the user and also increases the inconvenience in use.

### SUMMARY OF THE INVENTION

An objective of the invention is to provide a keyboard, which can offer touch function without additional space for disposing additional device and can increase the convenience in input operation to a user.

The keyboard of the invention includes a base plate, a plurality of key structures, a plurality of switches, and a capacitive touch sensing device. Each key structure is disposed above the base plate and includes a keycap. The keycap is capable of moving up and down relative to the base plate. Each switch corresponds to one of the keycaps and is disposed below the corresponding keycap. Each keycap is capable of moving toward the base plate to trigger the corresponding switch. The capacitive touch sensing device is disposed below the key structures for sensing a motion of an object performed on the keycaps.

Therefore, the keyboard of the invention can offer functions of keying and touch operation within a single device projection area simultaneously, which avoids the inconvenience that in the configuration of operate a conventional keyboard plus a touchpad in the prior art, a larger space is required to dispose the two input devices and the user needs to move his hand between the two input devices for changing inputting. Furthermore, the capacitive touch sensing device is disposed directly below the keycaps, so the user can use any hand or both hands to perform touch operation on the spot, which increases the convenience in operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sectional view of a keyboard of a preferred embodiment according to the invention.

FIG. 2 is a sectional view of a keyboard of another preferred embodiment according to the invention.

FIG. 3 is a sectional view of a keyboard of another embodiment according to the invention.

FIG. 4 is a sectional view of a keyboard of another embodiment according to the invention.

FIG. 5 is a sectional view of a keyboard of another embodiment according to the invention.

FIG. 6 is a sectional view of an illuminated keyboard of a preferred embodiment according to the invention.

FIG. 7 is a sectional view of an illuminated keyboard of another preferred embodiment according to the invention.

### DETAILED DESCRIPTION

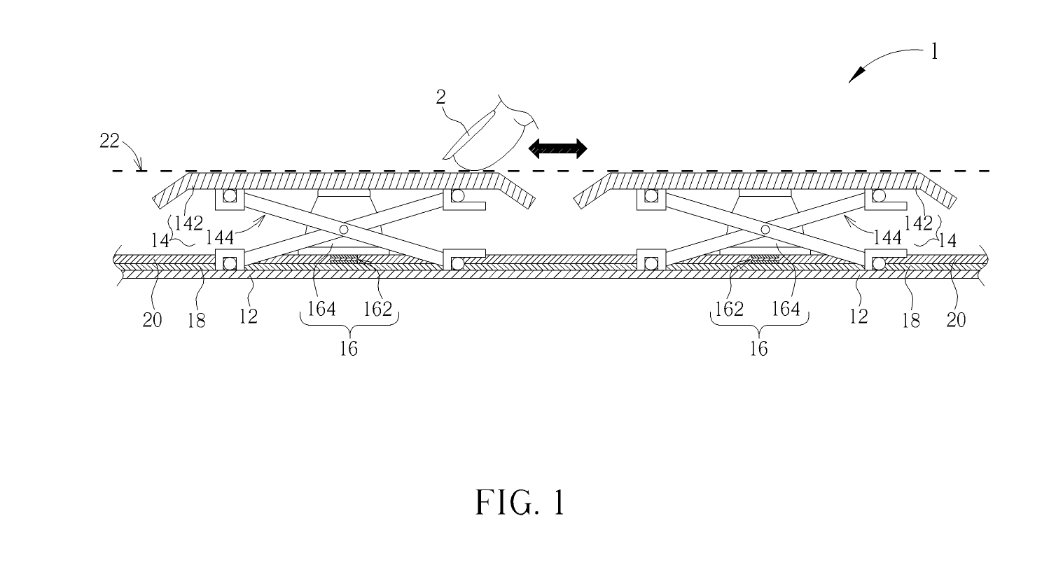

Please refer to FIG. 1, which is a sectional view of a keyboard 1 of a preferred embodiment according to the invention. The keyboard 1 includes a base plate 12, a plurality of key structures 14, a plurality of switches 16, a capacitive touch sensing device 18, and a membrane 20. Therein, the cutting plane for FIG. 1 does not actually pass through the switch 16, but for simple illustration, the switch 16 is still shown at the corresponding position in FIG. 1. Each key structure 14 is disposed above the base plate 12 and includes a keycap 142. The keycap 142 can move up and down relative to the base plate 12. Each switch 16 corresponds to one of the keycaps 142 and is disposed below the corresponding keycap 142. Each keycap 142 can move toward the base plate 12 to trigger the corresponding switch 16. The capacitive touch sensing device 18 is disposed below the key structures 14 for sensing a motion (shown by bold line with double arrows in FIG. 1) of an object 2 (such as a finger of a user) performed on the keycaps 142. Thereby, the keyboard 1 can offer functions of keying and touch operation within a single device projection area simultaneously.

Further, in the embodiment, each key structure 14 includes a lifting mechanism 144. The lifting mechanism 144 connects the base plate 12 and the keycap 142, so that the keycap 142 can move up and down relative to the base plate 12 through the lifting mechanism 144. The lifting mechanism 144 can be a scissors support in practice. The capacitive touch sensing device 18 is a touchpad. The switches 16 are disposed above the touchpad. In practice, the capacitive touch sensing device 18 needs to be holed at proper locations so that the lifting mechanism 144 can be connected to the base plate 12. Each switch 16 includes a pair of contacts 162 and an elastic dome 164 disposed on the pair of contacts 162. The elastic dome 164 can be pressed by the corresponding keycap 142 to short the pair of contacts 162. In the embodiment, the pairs of contacts 162 are formed on a membrane 20 disposed on the capacitive touch sensing device 18. Similarly, the membrane 20 needs to be holed at proper locations so that the lifting mechanism 144 can be connected to the base plate 12. Therein, in practice, the membrane 20 can be a conventional membrane 20, which is known by a skilled person in the art. For simple illustration of the membrane 20, the structure is shown only by hatched lines in FIG. 1; it is also applied to the following figures, which will not be described in addition.

For simple illustration, a press operation plane 22 (indicated by a dashed line in FIG. 1) is defined on the top surfaces of the keycaps 142. Therefore, the object 2 can press the keycaps 142 on the press operation plane 22 for performing keying; the object 2 also can slide on the press operation plane 22 to be sensed by the capacitive touch sensing device 18 for performing touch operation.

It is added that the structural height of the lifting mechanism 144 in FIG. 1 is exaggerated. In practice, the structural height depends on the effective sensing distance of the capacitive touch sensing device 18. The effective sensing distance for most current capacitive touchpads is usually within a few millimeters under the limitation of signal analysis technologies, but the invention is not limited thereto. Furthermore, the capacitive touch sensing device 18 can be realized by a conventional touchpad, but the invention is not limited thereto. In principle, any capacitive touch sensing device which can sensing the motion of the object 2 on the press operation plane 22 is applicable.

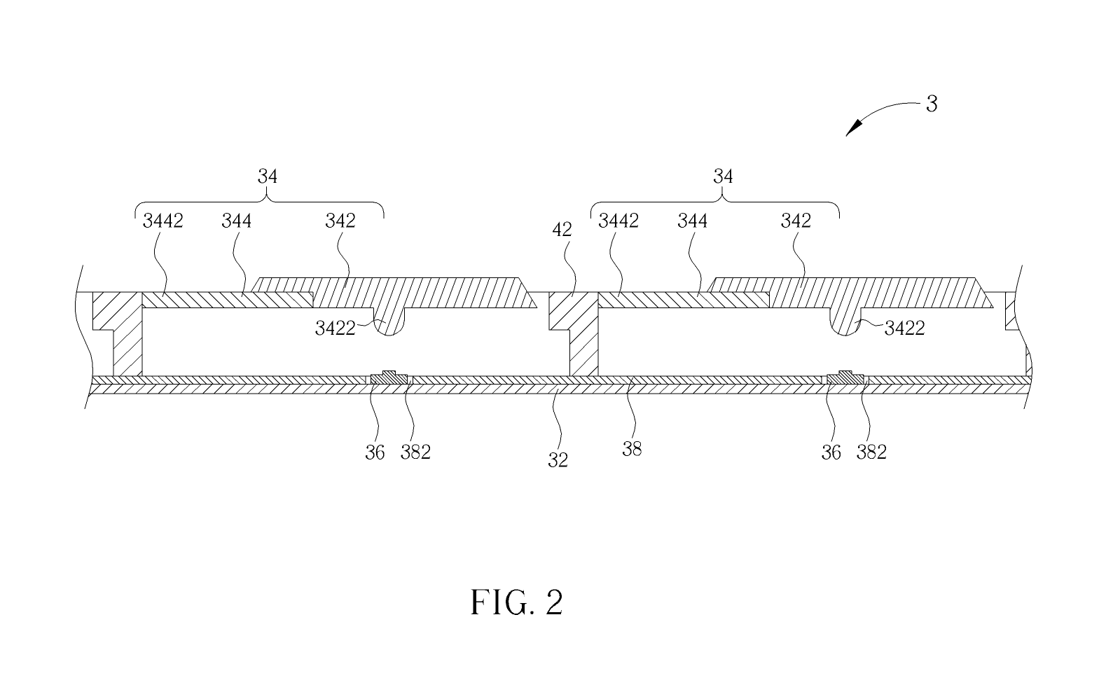

In addition, the switch 16 is realized by the pair of contacts 162 and the elastic dome 164; the lifting mechanism 144 is realized by a scissors support. However, the invention is not limited thereto. Please refer to FIG. 2, which is a sectional view of a keyboard 3 of another preferred embodiment according to the invention. The keyboard 3 includes a base plate 32, a plurality of key structures 34, a plurality of switches 36, a capacitive touch sensing device 38, and a top cover 42. For added description for the components of the keyboard 3, please refer to the relevant description of the components of the keyboard 1 with same denomination, which will not be described in addition. The following will be concentrated on the difference.

In the embodiment, the top cover 42 is disposed above the base plate 32. The lifting mechanism 344 of the key structure 34 is a cantilever. The fixed end 3442 of the cantilever is fixed connected to the top cover 42. The keycap 342 of the key structure 34 is fixed on the cantilever and is exposed out of the top cover 42. By use of the cantilever structure, it can be avoided to dispose too many structural members between the keycap 342 and the base plate 32, which is conducive to reduction of the height of the keycap 342 relative to the base plate 32. Therefore, in the embodiment, the switch 36 can be a touch switch. The keycap 342 includes a protrusion 3422 at its bottom surface, so that the keycap 342 can directly trigger the corresponding switch 36 by the protrusion 3422. In the embodiment, the capacitive touch sensing device 38 can be a touchpad which has a plurality of through holes 382. Each through hole 382 accommodates one of the switches 36. Therein, it is self-evident that the sensing circuit of the touchpad needs to bypass the through holes 382, which is known by a skilled person in the art without further illustration.

It is added that, in practice, the top cover 42 can be connected to the base plate 32 at the middle portion of the keyboard 3. In such case, the touchpad needs to form through holes thereon for the top cover 42 to be connected to the base plate 32. The top cover 42 may also be connected to the base plate 32 at the circumference of the keyboard 3, so as to avoid the influence on the sensitivity of sensing the motion of the object 2 due to too many through holes formed on the touchpad. It is added more that in the embodiment, the top cover 42 is disposed also against the capacitive touch sensing device 38 to improve the fixity of the capacitive touch sensing device 38 to enhance the accuracy of the capacitive touch sensing device 38 sensing the motion of the object 2. Furthermore, the cantilever structure is conducive to reduction of the height of the keycap 342 relative to the base plate 32. However, in practice, the elastic dome 164 can still be disposed between the keycap 342 and the base plate 32 to enhance the restoration force to the cantilever and also to reduce the deformation of the cantilever when in use so as to expand the service life.

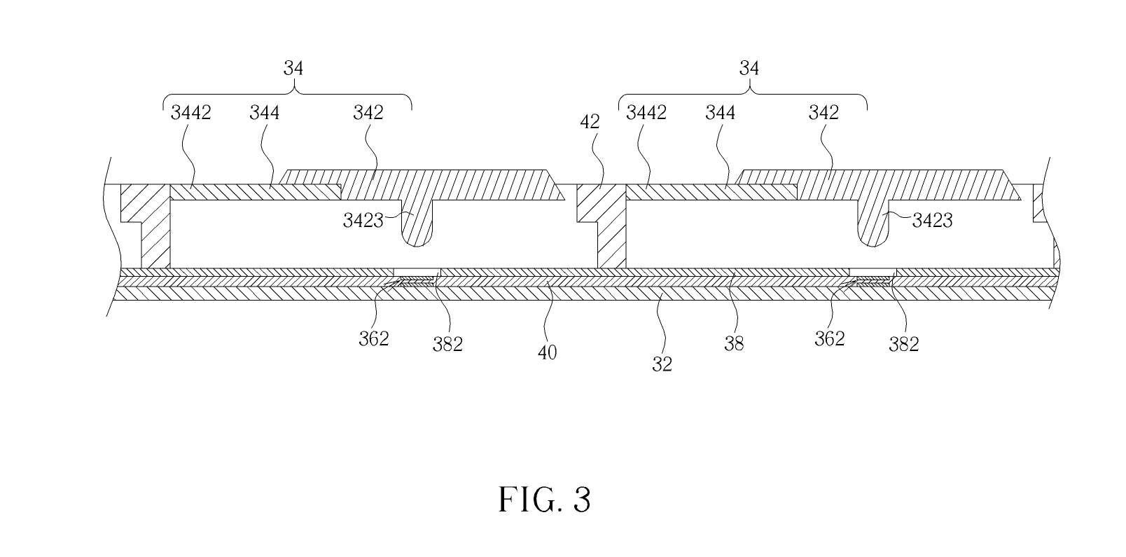

In addition, because of the nature of the cantilever structure, the protrusion 3422 of the keycap 342 can be designed to be very close to the base plate 32. In such case, the switches 36 can be also formed on a membrane, and it is unnecessary to dispose the elastic dome 164 in FIG. 1 herein, as shown in FIG. 3. In the embodiment, the membrane 40 is disposed between the base plate 32 and the capacitive touch sensing device 38. The membrane 40 thereon forms a pair of contacts 362 corresponding to the through hole 382 to be a switch. Therefore, the protrusion 3423 of the keycap 342 can pass through the through hole 382 to short the pair of contacts 362, which also realizes keying function. Furthermore, the capacitive touch sensing device 38 is located above the membrane 40 to be closer to the object, so the configuration shown in FIG. 3 is conducive to sensing the motion of the object 2 by the capacitive touch sensing device 38. For added description for the components of the keyboard in FIG. 3, please refer to the relevant description of the components of the keyboards with same denomination in the above embodiments, which will not be described in addition.

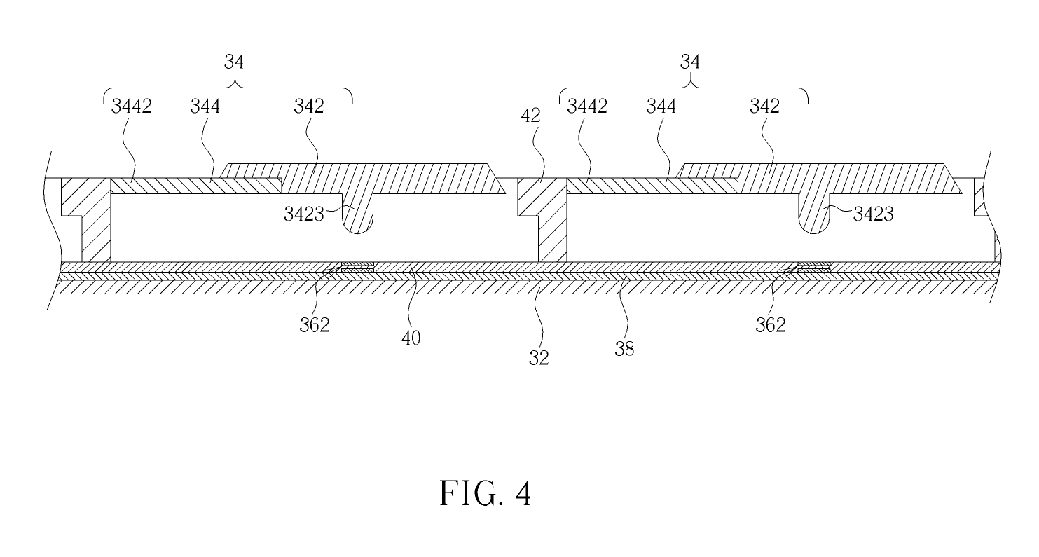

Please refer to FIG. 4, which is a sectional view of a keyboard of another embodiment according to the invention. The keyboard in FIG. 4 is substantially similar in structure to the keyboard in FIG. 3. The main difference is that the capacitive touch sensing device 38 is disposed between the base plate 32 and the membrane 40. The protrusion 3423 of the keycap 342 can short the corresponding pair of contact 362 without passing through the capacitive touch sensing device 38, so it is unnecessary to the capacitive touch sensing device 38 to form through holes thereon, which increases the accuracy of the motion of the object 2 and reduces the difficulty degree in processing and design of the capacitive touch sensing device 38. For added description for the components of the keyboard in FIG. 4, please refer to the relevant description of the components of the keyboards with same denomination in the above embodiments, which will not be described in addition.

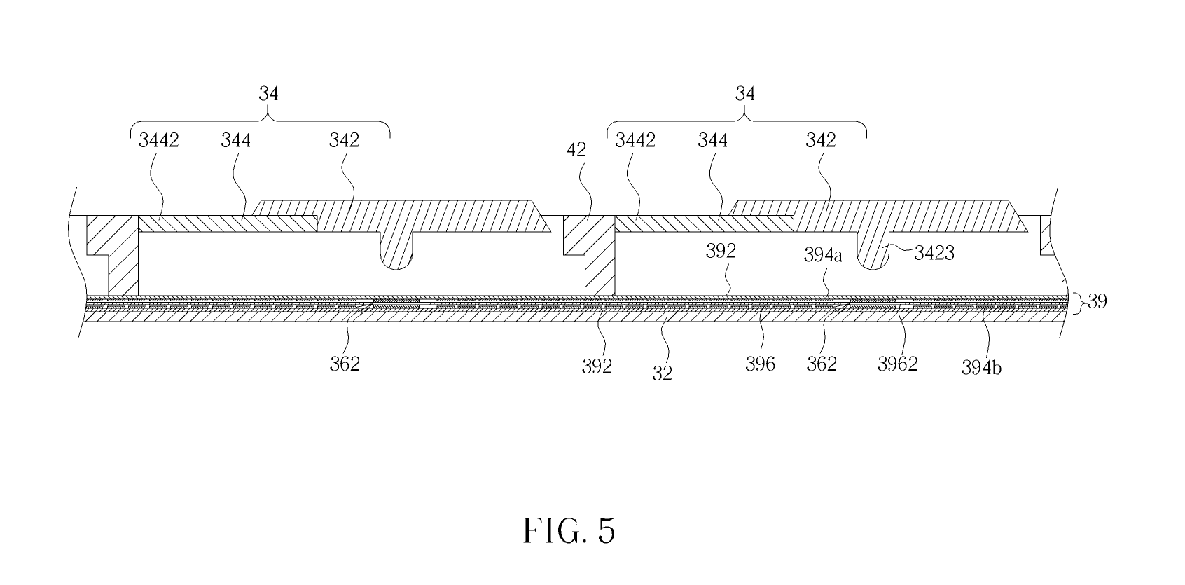

Please refer to FIG. 5, which is a sectional view of a keyboard of another embodiment according to the invention. The keyboard in FIG. 5 is substantially similar in structure to the keyboard in FIG. 2. The main difference is that the switch consisting of one pair of contacts 362 is integrated into the capacitive touch sensing device 38, which reduces the amount of the components and also improves the processing quality. In the embodiment, the capacitive touch sensing device 39 includes a capacity sensing circuit and a plurality of pairs of the contacts 362 disposed on the capacity sensing circuit. In practice, two substrates 392 thereon form a plurality of X-axis electrode pads 394a and a plurality of Y-axis electrode pads 394b respectively. The X-axis electrode pads 394a and the Y-axis electrode pads 394b are connected in series respectively. The two substrates 392 are combined oppositely with an intermedium sheet 396 disposed therebetween, so as to form the capacity sensing circuit. The intermedium sheet 396 thereon forms through holes 3962 at positions corresponding to the protrusions 3423, where the pair of contacts 362 is formed on the substrates 392. Thereby, the pair of contacts 362 is open in normal state and can be shorted due to a pressing by the protrusion 3423. However, the integrated capacitive touch sensing device according to the invention is not limited thereto. A skilled person in the art can integrate one pair of contacts into a capacity sensing circuit according to the formation mechanism of the capacity sensing circuit, which is not described in details herein. For added description for the components of the keyboard in FIG. 5, please refer to the relevant description of the components of the keyboards with same denomination in the above embodiments, which will not be described in addition.

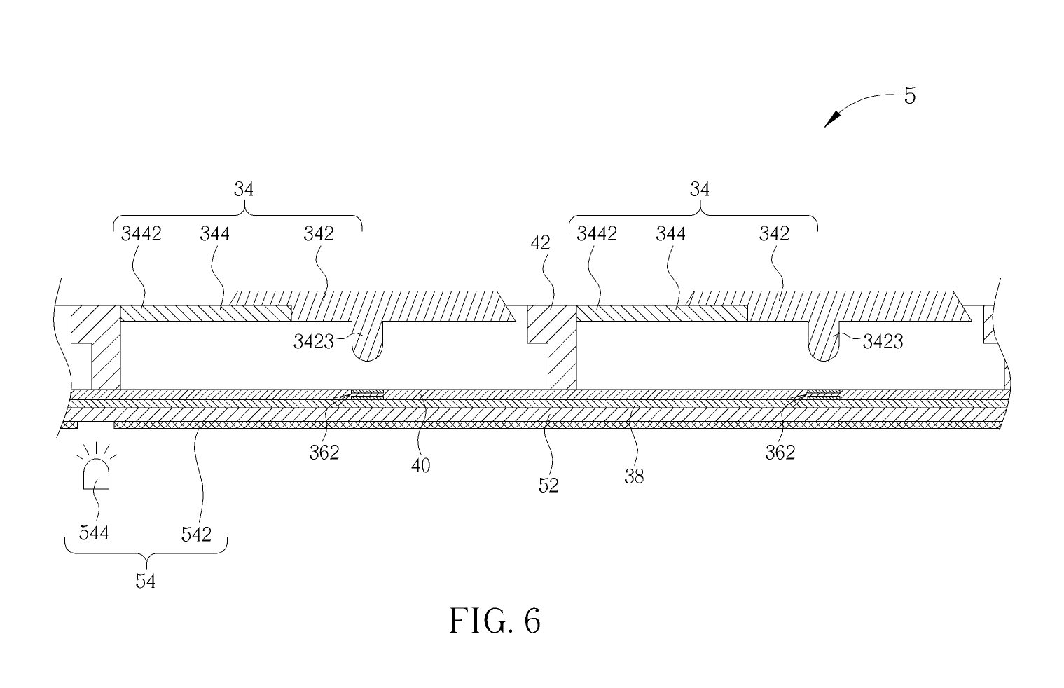

In practice, the invention also can be applied to illuminated keyboards. Please refer to FIG. 6, which is a sectional view of an illuminated keyboard 5 of a preferred embodiment according to the invention. For simple illustration, the structure of the illuminated keyboard 5 is based on the keyboard in FIG. 4. In the embodiment, the base plate 52 of the illuminated keyboard 5 is a plate of light penetrable material. The illuminated keyboard 5 includes a back light module 54 in addition. The back light module 54 includes a reflection sheet 542 and at least one light-emitting unit 544. The reflection sheet 542 is disposed on the bottom surface of the base plate 52 for reflecting light travelling inside the base plate 52. In practice, the reflection sheet 542 can be formed by coating the bottom surface of the base plate 52 with reflective material. The light-emitting unit 544 such as light-emitting diode is used for emitting light to enter the base plate 52. In practice, the disposition of the light-emitting unit 544 is not limited to that shown in FIG. 6; in principle, it is applicable as long as light emitted by the light-emitting unit 544 can enter the base plate 52. In the embodiment, the capacitive touch sensing device 38 is still disposed above the base plate 52. Thereby, a user can have the operation convenience of inputting by keys with back light by the illuminated keyboard 5 and performing touch operation by the capacitive touch sensing device 38 simultaneously. It is added that the structure design for the back light of the illuminated keyboard 5 can also be applied to the keyboards in the above embodiments. The practical structure therefor can be realized on the disclosure by the illuminated keyboard 5 and is not described herein.

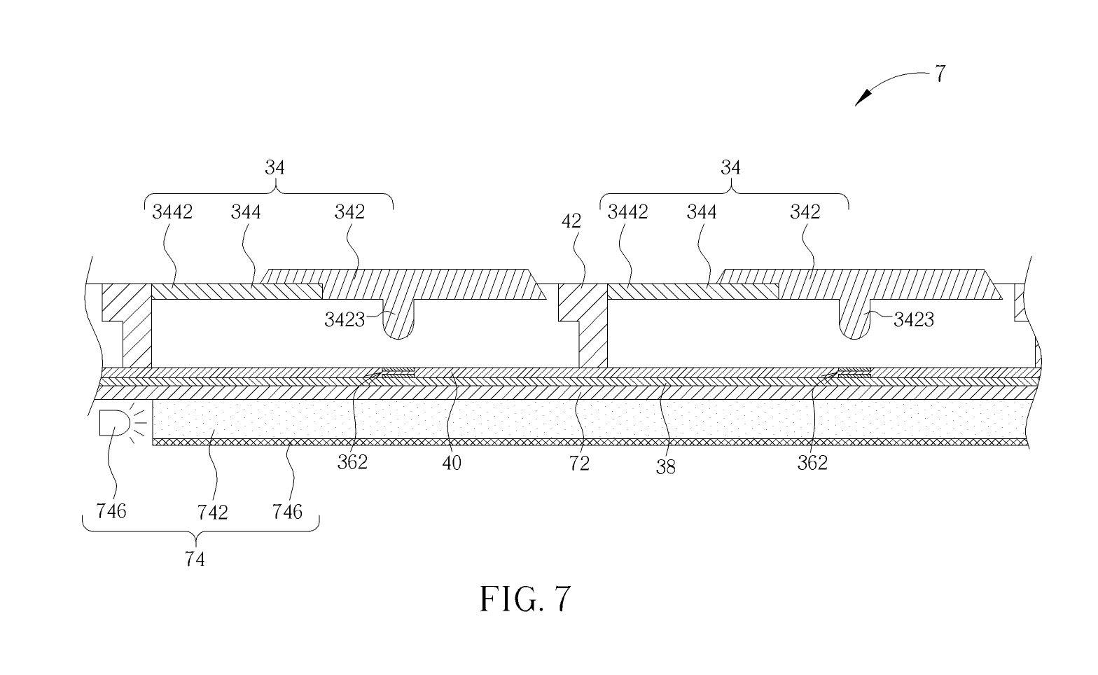

In the structure of the illuminated keyboard 5, the light-guiding plate and the base plate 52 are integrated, which is conducive to reduction in the thickness of the illuminated keyboard 5; however, the invention is not limited thereto. Please refer to FIG. 7, which is a sectional view of an illuminated keyboard 7 of another preferred embodiment according to the invention. Similarly, for simple illustration, the structure of the illuminated keyboard 7 is based on the keyboard in FIG. 4. In the embodiment, the illuminated keyboard 7 includes a back light module 74 in addition, disposed below the base plate 72 of the illuminated keyboard 7. The back light module 74 includes a light-guiding plate 742, a reflection sheet 744, and at least one light-emitting unit 746. The reflection sheet 744 is disposed on the bottom surface of the light-guiding plate 742 for reflecting light travelling inside the light-guiding plate 742. In practice, the reflection sheet 744 can be formed by coating the bottom surface of the light-guiding plate 742 with reflective material. The light-emitting unit 746 such as light-emitting diode is used for emitting light to enter the light-guiding plate 742. In practice, the disposition of the light-emitting unit 746 is not limited to that shown in FIG. 7; in principle, it is applicable as long as light emitted by the light-emitting unit 746 can enter the light-guiding plate 742. The base plate 72 of the illuminated keyboard 7 is no longer used as a light-guiding plate. Back light provided by the back light module 74 emits upward from under the base plate 72. In practice, the base plate 72 can be holed partially or be made of light penetrable material, such that the back light can pass through the base plate 72. In the embodiment, the capacitive touch sensing device 38 is still disposed above the base plate 72, i.e. above the light-guiding plate 742. Thereby, a user can have the operation convenience of inputting by keys with back light by the illuminated keyboard 7 and performing touch operation by the capacitive touch sensing device 38 simultaneously. It is added that the structure design for the back light of the illuminated keyboard 7 can also be applied to the keyboards in the above embodiments. The practical structure therefor can be realized on the disclosure by the illuminated keyboard 7 and is not described herein.

As discussed above, compared with the prior art, the function of the keyboard of the invention is improved. A user can perform keying and touch operation within a single device projection area simultaneously, which avoids the inconvenience of using a conventional keyboard plus a touchpad simultaneously in the prior art. Furthermore, the capacitive touch sensing device is disposed directly below the keycaps, so a user can use any hand or both hands to perform touch operation on the spot, which increases the operation convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyboard, comprising:
a base plate;
a plurality of key structures, each key structure being disposed above the base plate and comprising a keycap, the keycap being capable of moving up and down relative to the base plate;
a plurality of switches, each switch corresponding to one of the keycaps and being disposed below the corresponding keycap, each keycap being capable of moving toward the base plate to trigger the corresponding switch; and
a capacitive touch sensing device disposed below the key structures for sensing a motion of an object performed on the keycaps.

2. The keyboard of claim 1, wherein each key structure comprises a lifting mechanism, and the keycap is capable of moving up and down relative to the base plate through the lifting mechanism.

3. The keyboard of claim 2, wherein the lifting mechanism is a scissors support.

4. The keyboard of claim 2, further comprising atop cover, disposed above the base plate, the lifting mechanism being a cantilever, a fixed end of the cantilever being fixedly connected to the top cover, the keycap being fixed on the cantilever and exposed out of the top cover.

5. The keyboard of claim 1, wherein each switch comprises a pair of contacts and an elastic dome disposed on the pair of contacts, and the elastic dome is capable of being pressed by the corresponding keycap to short the pair of contacts.

6. The keyboard of claim 5, wherein the pairs of contacts are formed on a membrane.

7. The keyboard of claim 6, wherein the capacitive touch sensing device is a touchpad, disposed below or above the membrane.

8. The keyboard of claim 6, wherein the capacitive touch sensing device is disposed on the membrane.

9. The keyboard of claim 1, wherein the keycap comprises a protrusion, and the keycap directly contact the corresponding switch by the protrusion.

10. The keyboard of claim 1, wherein the capacitive touch sensing device comprises a capacity sensing circuit, each switch comprises a pair contacts, and the pairs of contacts are disposed within the capacity sensing circuit.

11. The keyboard of claim 1, further comprising a back light module, wherein the base plate is a plate of light penetrable material, the back light module comprises a reflection sheet and at least one light-emitting unit, the reflection sheet is disposed below the base plate, the light-emitting unit is used for emitting light to enter the base plate, and the capacitive touch sensing device is disposed above the base plate.

12. The keyboard of claim 1, further comprising a back light module disposed below the base plate, wherein the back light module comprises a light-guiding plate, a reflection sheet, and at least one light-emitting unit, and the capacitive touch sensing device is disposed above the light-guiding plate.
